(19) United States
(12) Patent Application Publication
(10) Pub. No.: US 2013/0041748 A1
(43) Pub. Date: Feb. 14, 2013

(54) CONVERSION TYPE TO CONVERSION TYPE FUNNELING

(71) Applicants: Sissie Ling-Ie HSIAO, Santa Clara, CA (US); Chao CAI, San Jose, CA (US); Nicholas SECKAR, Mountain View, CA (US)

(72) Inventors: Sissie Ling-Ie HSIAO, Santa Clara, CA (US); Chao CAI, San Jose, CA (US); Nicholas SECKAR, Mountain View, CA (US)

(73) Assignee: Google Inc.

(21) Appl. No.: 13/206,402

(22) Filed: Aug. 9, 2011

(51) Int. Cl. G06Q 30/00

(52) U.S. Cl. 705/14.41

(57) ABSTRACT

Methods, systems, and apparatus, including computer programs encoded on a computer storage medium including receiving first information as to completion of at least a first conversion and a second conversion by a user, grouping the received first information into at least one sequence of events, receiving second information as to which conversions are to be included in a report, and a time frame with respect to completion of the conversions, extracting information from the at least one sequence of events that is pertinent to the received second information, and providing the extracted information in the form of a report.

### BACKGROUND

The Internet provides access to a wide variety of content. For instance, images, audio, video, and web pages for many different topics are accessible through the Internet. The accessible content provides an opportunity to present advertisements to users. Advertisements can be placed within content, such as a web page, image or video, or the content can trigger the display of one or more advertisements, such as presenting an advertisement in an advertisement slot within the content and/or in an advertisement slot of a pop-up window or other overlay.

Advertisers decide which ads are displayed within particular types of content using various advertising management, or analytics, tools. These tools also allow an advertiser to track the performance of various advertisements (ads) or advertising campaigns (ad campaigns). The parameters used to determine when to display a particular ad can also be changed using advertising management tools.

The data that is used to generate the performance measures for the advertiser generally includes all data that is available. This data usually includes a combination of data from multiple servers. The combined data is large enough that performance measures generated from the data are needed to provide an efficient way of understanding the data. The data, therefore, must be processed. Processing of the data to generate useful and accurate performance measures involves a number of obstacles. For instance, if a performance measure is based upon a user's actions over a period of time, a cookie can be used to track a user's actions over a period of time. If this cookie is removed during the period of time, the data will not contain an accurate account of the user's actions during a period of time. The data can also contain recorded user actions that are deemed significant to an advertiser. These actions, which can be any recordable event, are called conversions. Conversions are attributable to a certain action or actions in a conversions path. Identifying those actions can be valuable to a content provider. The data, however, contains numerous actions that could be attributable to conversions. In addition, the data may also contain user actions that do not include any conversions. Thus, processing the data to provide accurate and reliable performance measures based upon all the possible actions has a number of challenges.

### SUMMARY

In general, one innovative aspect of the subject matter described in this specification can be embodied in methods that include receiving first information as to completion of at least a first conversion and a second conversion by a user, grouping the received first information into at least one sequence of events, receiving second information as to which conversions are to be included in a report, and a time frame with respect to completion of the conversions, extracting information from the at least one sequence of events that is pertinent to the received second information; and providing the extracted information in the form of a report. Other embodiments include corresponding systems, apparatus, and non-transitory or tangible computer readable-media, configured to perform the actions of this method.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of an example environment in which an advertisement management system manages advertising services in accordance with an illustrative embodiment.

FIG. 2 is a flow diagram of a process for integrating user interaction log data in accordance with an illustrative embodiment.

FIG. 3 is a block diagram that illustrates user interaction data being updated during a user interaction log data integration process in accordance with an illustrative embodiment.

FIG. 4a illustrates an example conversion path with a first interaction, assist interactions, and a last interaction.

FIG. 4b shows the determination of the path length based on the user interactions from FIG. 4a.

FIG. 4c shows the time lag from the first user interaction to the conversion based on the user interactions from FIG. 4a.

FIG. 5 is an illustrative user interface that may be presented to an advertiser to allow the advertiser to obtain desired information in the form of a report, in accordance with a first embodiment of the invention.

FIG. 6 is a block diagram of elements that may be utilized to provide the report information to a user, in accordance with the first embodiment of the invention.

FIG. 7 is an illustrative example of a report that can be provided to an advertiser, in accordance with the first embodiment of the invention.

FIG. 8 is a block diagram of a computer system in accordance with an illustrative embodiment.

Like reference numbers and designations in the various drawings indicate like elements.

### DETAILED DESCRIPTION

Content providers (e.g., advertisers) may access various reports that disclose information regarding various user interactions with the content. Each user interaction can include a number of dimensions, which can contain data associated with the user interaction. Reports can be generated to provide a content provider (or advertiser) with information regarding the user interactions. Such reports can have a large number of unique user interactions. Rules can be generated that group various user interactions that satisfy various group rules. Reports can be generated which include the various grouped user interactions. The user interactions may include conversion path data that comprises the source/medium that a user used to access the content provider's content.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or non-selections of the content following the presentation of the content). Thus, a user interaction does not necessarily require a selection of the content (or any other affirmative action) by the user. For example, the user reviewing content for a period of time may be considered an interaction. A user interaction may also include a user typing in the URL of a content provider directly into the web browser.

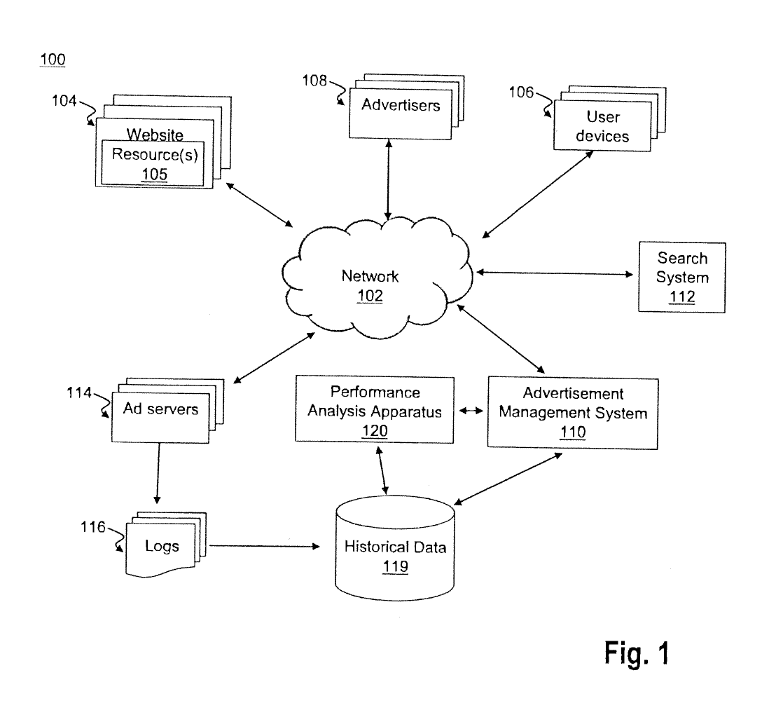

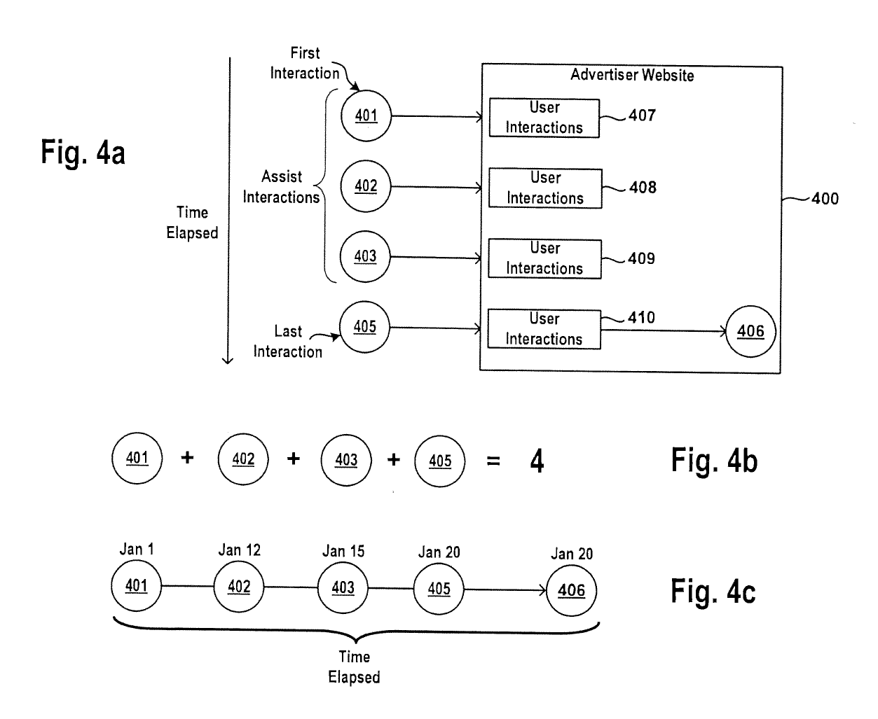

An analysis tool (i.e. performance analysis apparatus 120 of FIG. 1) may analyze conversion path data to assist an advertiser to determine an effective advertising strategy. The analysis and reports of the conversion path data can enable an advertiser to make advertising budget allocation decisions. The advertising decisions may lead to a greater number of users reaching the advertiser's content. On many occasions, a user interaction with the advertiser's content may not initially lead to a conversion action by the user. The user may review the content many times prior to performing a conversion action (See, FIGS. 4a-c). Embodiments of the analysis tool provide the ability to segment the conversion path data based on dimensions and metrics related to conversion path attributes. A path-level dimension (dimension) may represent one or more characteristics of one or more interactions that are part of a conversion path. A dimension may be a variable that is assigned a character or string value based on the characteristics of the user interaction with the advertiser's content. A path-level metric (metric) may include a numerical characteristic of the entire conversion path. A metric may be a variable that is assigned an integer or floating value that characterizes the entire conversion path.

In particular, the analysis tool may allow an advertiser to segment the conversion path data based on the path or paths traversed by a user in navigating to the advertiser's content. Embodiments of the analysis tool may focus on the user interactions that occurred just prior to the user accessing the advertiser's website. In another embodiment, the analysis tool may track or analyze all user interactions prior to the latest conversion, including, interaction with the content provider's website. (e.g. repeat customers or the like) For example, an advertiser may use a plurality of marketing channels (search terms, social media, e-mail campaigns, or the like) to drive the user traffic to their site, leading to desired user actions on their website (i.e. conversions). The analysis tool may identify the marketing channel that drove the users to the online content. Moreover, the analysis tool may attribute additional information to a user interaction (e,g., a first interaction label, an assist interaction label, a last interaction label, path length information, time lag information, or the like).

User interaction measures can include one or more of time lag measures (i.e., measures of time from one or more specified user interactions to a conversion), path length measures (i.e., quantities of user interactions that occurred prior to conversions), user interaction paths (i.e., sequences of user interactions that occurred prior to the conversion), assist interaction measures (i.e., quantities of particular user interactions that occurred prior to the conversion), and assisted conversion measures (i.e., quantities of conversions that were assisted by specified content).

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the websites 104. Data about the resources 105 can be indexed based on the resource 105 with which the data is associated. The indexed and, optionally, cached copies of the resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the web page 104, a rendering of the resource 105, and the URL of the web page 104. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by a user device 106 or provided to the user device 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data representing the selection of the advertisement can be stored in the log file 116, a cookie, or the historical data store 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106.

The log files 116, or the historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures measuring user interactions with content that occur prior to a conversion. A conversion occurs when a user performs a specified action, and a conversion path includes a conversion and a set of user interactions occurring prior to the conversion by the user. Any “recordable” user interaction or user interactions can be deemed a conversion. For example, dialing a phone number displayed on a website may be a conversion and may be tracked. What constitutes a conversion may vary from case to case and can be determined in a variety of ways. For example, a conversion may occur when a user clicks on an advertisement, is referred to a web page or website, and then consummates a purchase there before leaving the web page or website. As another example, a conversion may occur when a user spends more than a given amount of time on a particular website. Data from multiple user interactions can be used to determine the amount of time at the particular website.

Actions that constitute a conversion can be specified by each advertiser. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used.

To track conversions (and other interactions with an advertiser's website), an advertiser can include, in the advertiser's web pages, embedded instructions that monitor user interactions (e.g., page selections, content item selections, and other interactions) with advertiser's website, and can detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is referenced by the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/%affiliate_identifier%promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not provided any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path is a set of user interactions by a particular user prior to and including a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The advertisement management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1000) may specify a lookback window of 90 days.

In some implementations, an advertiser 108 can specify a lookback window to use when requesting a performance report, such as by entering a number of days or by selecting a lookback window from a list of specific lookback windows (e.g., thirty days, sixty days, ninety days). Allowing an advertiser to configure the lookback window of their performance reports enables the advertiser to choose a lookback window that corresponds to conversion cycles of their products. Allowing lookback window configuration also enables advertisers to experiment with different lookback windows, which can result in the discovery of ways to improve conversion rates.

Other factors can contribute to reporting on partial conversion paths. For example, as mentioned above, user interaction data used as a basis for a report can be associated with unique identifiers that represent a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a web page (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

To view a report which reduces bias caused from partial conversion paths, an advertiser can specify a lookback window for the report. As described above, the lookback window specifies that the user interaction data used to generate the report are user interaction data that are associated with unique identifiers that have initialization times that are prior to a specified period (e.g., thirty days, sixty days, ninety days) before the conversions. Thus, conversions for which user interaction data that are associated with unique identifiers having initialization times that are after the specified period are excluded from inclusion as a basis for the report. A unique identifier that has a recent initialization time indicates that the unique identifier may have been recently reinitialized on the user device that the unique identifier represents. Accordingly, user interaction data associated with the relatively new unique identifier may represent only a partial conversion path. Alternatively, conversions for which user interaction data that are associated with unique identifiers having initialization times that are after the specified period are included in the report. To reduce bias, any user interaction included in the conversion path that occurred after the specified period are removed from the conversion path prior to being included in the report.

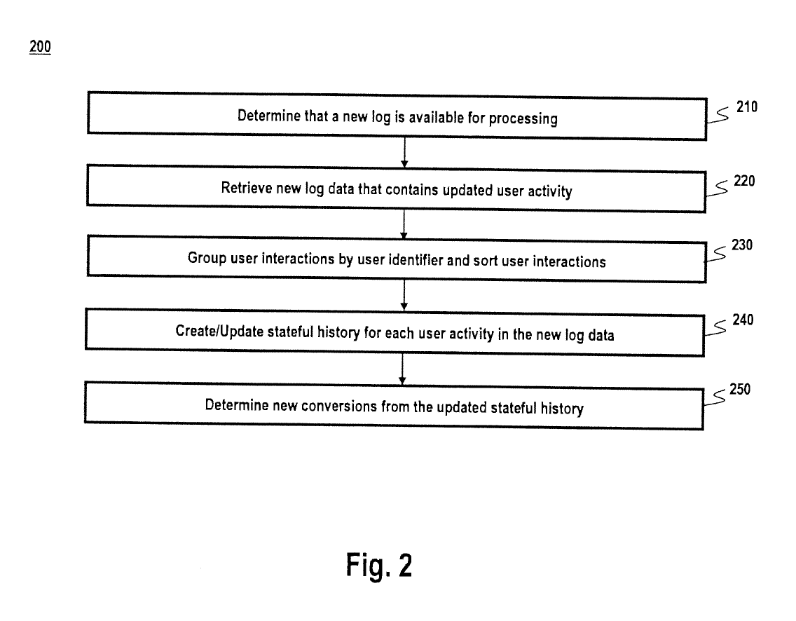

FIG. 2 is a flow diagram of a process for integrating user interaction log data in accordance with an illustrative embodiment. The process 200 is a process that updates conversion paths and determines conversions based upon the updated conversion paths of users.

The process 200 can be implemented on the advertisement management system 110, the performance analysis apparatus 120, or another computing device. In one implementation, the process 200 is encoded on a computer-readable medium that contains instructions that when executed by a computing device cause the computing device to perform operations of process 200.

As described above, log files 116 may contain user interaction data. A log file 116 may be combined with user interaction data from other logs from other servers, including those that implement the search system 112, prior to processing. Processing starts with the computing device that implements the process 200 that determines that a new log is available for processing (210). For example, a notification can be sent to the computing device indicating that a new log is ready for processing, or the existence of a new log can indicate that the new log is ready for processing.

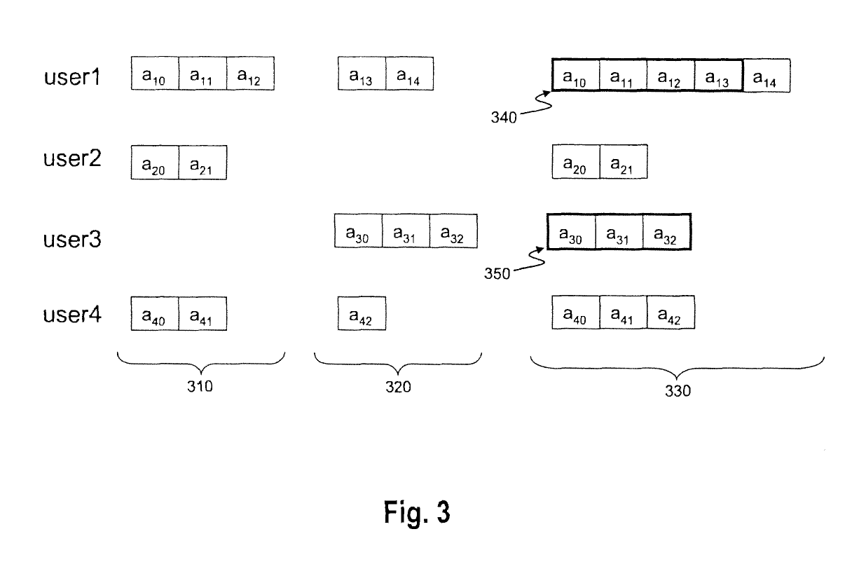

Next, the new log is retrieved (220). The new log may be retrieved over the network 102. The stateful history for each user is updated based upon the user activity indicated by the new log. The new log can contain information relating to user interactions for numerous users. The historical data store 119 contains user interaction data from previously processed log files. The user interaction data contained within the historical data store 119 can be stateful, in that the user interaction data can be grouped by user identifier and ordered chronologically. FIG. 3 is a block diagram that illustrates user interaction data being updated during a user interaction log data integration process 200 in accordance with an illustrative embodiment. FIG. 3 illustrates four example user identifiers, although the historical data store 119 and log files 116 can contain data associated with thousands or millions of different user identifiers. In one embodiment, previously stored user interaction data 310 are stored in the historical data store 119. As illustrated, no user interaction data associated with user identifier 3 has been previously stored in the historical data store 119.

The new log can contain user interaction data for one or more user identifiers. The user interaction data can be grouped by user identifiers and then sorted chronologically (230). Column 320 illustrates grouped and sorted user interaction data. As illustrated, user identifier 2 does not include any new user interaction data, and user identifiers 1, 3, and 4 have updated user interaction data. For instance, the new log file includes user interaction data associated with user interactions a₁₃ and a₁₄ that are associated with user identifier 1. The grouped and sorted user interaction data can then merged with the user interaction data stored in the historical data store 119 (240). If a user identifier previously existed in the historical data store 119, the new user interaction data are added to the previous user interaction data. Otherwise, the new user interaction data is added with a new user identifier.

Column 330 illustrates the updated user interaction data for each of the user identifiers. Based upon the updated user interaction data, any conversions that occurred in each of the updated paths of user interactions can be determined (250). User interaction paths are constrained to those user interactions that are related to a particular advertiser 108. The conversion interactions of the particular advertiser 108 are used to determine if a conversion has occurred. As an example, assume that user interactions a₁₃ and a₃₂ represent conversion interactions. Accordingly, conversion paths 340 and 350 are found. Once found, the conversion paths can be written to another portion of the historical data store 119 or another data store for further analysis.

Each user interaction includes a set of data or dimensions associated with the user interaction. The dimensions can be sparsely populated, such that, any user interaction may have data relating to a subset of the dimensions. A large number of conversion paths can be generated based upon received user interaction data. Various reports regarding how a campaign or an advertiser's placements are performing can include various information regarding the conversion paths. Given the large potential number of conversion paths, various conversion paths can be grouped together to reduce the number of distinct conversion paths that are reported. In an illustrative embodiment, conversion paths that have the same number of user interactions and have corresponding data can be aggregated.

Dimensional data of user interactions can be sparsely populated. Using a single dimension to aggregate conversion paths can result in a large number of aggregated conversion paths that do not have data associated with the aggregated dimension. In an illustrative embodiment, multiple dimensions can be used to aggregate various conversion paths. A sorted list of dimensions can be used to determine, for each user interaction, a first matching dimension that contains data. If there is no matching dimension for any particular user interaction a default dimension or data value can be specified. For instance, a default dimension that is not sparsely populated can be used as the default dimension or a text string, such as, “unavailable,” “(none),” or “ ” can be used as a default value.

Using the sorted list of dimensions, each conversion path can be converted into a dimensional path. A dimensional path contains dimensional elements that correspond to the user interactions of a conversion path. The dimensional element can contain or reference data from the first dimension that contains data from the corresponding user interaction. For instance, assume the sorted list of dimensions contains dimension₁, dimension₂, and dimension₃ and a user interaction contains data in dimension₂, and dimension₃ but not in dimension₁. A dimensional element corresponding to this user interaction would contain or reference the dimension₂ data from the user interaction, since dimension₂ was the first dimension of the user interaction that contained data. A dimension is not limited to having data from a single dimension. For instance, the data from multiple dimensions can be combined into a dimension. In addition, the dimensional element may contain additional information from the user interaction beyond the first matching dimension.

In one embodiment, conversion paths are converted into dimensional paths by adding a reference to the dimensional data to each of the user interactions. In another embodiment, dimensional paths that are separate from the conversion paths are created. In this embodiment, the dimensional paths can be stored in a location different from the location that stores the conversion paths. Regardless of how the dimensional paths are implemented, the dimensional paths can be aggregated based upon the length and the dimensional elements of the dimensional paths.

In one embodiment, the dimensional elements contain the dimensional data as well as other data from the corresponding user interaction. For example, a conversion interaction can include a value associated with the conversion. As the dimensional paths are aggregated, the value of all conversion paths associated with the aggregated dimensional paths can be also be aggregated. This aggregated value can be included in a report.

FIG. 4a illustrates an example conversion path. Initially a user may access the advertiser website 400 by performing a search in a search engine (i.e., search engine 1) and by selecting a sponsored link displayed within the search results. This type of interaction may be referred to as having the source: “search engine 1” and medium “cpc” (cost per click) or Search Engine 1/cpc 401. Accordingly, the first interaction between this user and the advertisers website 400 occurred by search engine 1/cpc 401. Since the user reached the advertiser website 400, the user may perform user interactions 407. The user transactions 407 may not lead to a conversion according to this example. Next, the user may be referred to the advertise website 400 by a social networking site 1/referral 402. After the referral the user may perform user interactions 408 which may not lead to an advertiser designated conversion. Next the user may reach the advertisers website 400 by conducting a search for the advertiser's trademark or domain name and selecting an organic search result, i.e. search engine 1/organic 403. After accessing the advertisers website 400 for the third time the user may perform interactions 409, which may not lead to a conversion. Since the user has been on this website three times the user may allow the browser to pull up the website directly on the fourth interaction, i.e. (none)/direct 405. Upon arriving at the advertiser website, the user may conduct various user interactions 410 which may lead to a conversion 406. In response to reaching a conversion the performance analysis apparatus 120 may determine that the conversion path includes a first interaction (search engine 1/cpc 401), second interaction (social networking site 1/referral 402), third interaction (search engine 1/organic 403), and fourth interaction (none/direct 405).

The performance analysis apparatus 120 may access historical data 119 to determine the conversion path that led the user to the advertiser's website. Moreover, the performance analysis apparatus 120 may designate attributions such as, first interaction, assist interactions, and last interaction to various nodes in the conversion path. For example, search engine 1/cpc 401 would be designated the first interaction since the user accessed the advertiser website 400 through search engine 1/cpc 401. The last interaction, would be none/direct 405 because it was the interaction that led to the conversion 406. All interactions other than the last interaction prior to reaching the advertiser's website would be referred to as assist interactions. Accordingly, in the example discussed in FIG. 4a, search engine 1/cpc 401, social networking site 1/referral 402, and search engine 1/organic 403 would be designated the attribution of the assist interactions. Also shown in FIG. 4a is the time period from the first interaction to the conversion 406.

FIG. 4b shows a calculation of the overall path length. Since there are 4 nodes 401, 402, 403 and 405 prior to the conversion the conversion path length for the example in FIG. 4a would be 4.

FIG. 4c shows the period of time that may have elapsed from the first interaction to the conversation 406. As shown in FIG. 4c the first interaction occurred on January 1, the second interaction occurred on January 12, the third interaction occurred on January 15, and the fourth interaction occurred on January 20. Accordingly, there was a 20 day time lag between the first interaction and the conversion. The analytic tool can determine that each of the four interactions were conducted by the same user and create a conversion path. In one embodiment, the interaction level attributes, the path length, time elapsed and other interaction related dimensions may be stored in an aggregate table. An advertiser may be able to segment the conversion data using interaction level filters or path level filters.

A first embodiment provides reporting information to help analytic tool users, such as advertisers, understand the relationship between goals and transactions that are completed, across time, by visitors. This helps analytic tool users, especially advertisers, understand if optimizing for certain types of ‘shallow goals’ (e.g. “Account Sign-up”) lead to other types of ‘deep goals’ (e.g. “Completed Order”) further down the line, at what rate, etc.

Using this information, advertisers can determine the “lifetime value” of a visitor, optimize for ‘shallow goal completion’ with better insight into eventual ‘deep goal’ value, and potentially even approximate how many ‘deep goals’ will be completed given an understanding of how many visitors are at an earlier stage (e.g. having completed a ‘shallow goal’ but not a ‘deep goal’ yet).

Analytic tool users and advertisers want to track return on investment, or ROI. Typically, there are many ‘actions’ that can happen on a site that can indicate ROI, or intent to spend (indirect ROI). One example is an Account Sign-up (which results in no transfer of dollars) vs. a Sale (which results in a direct transfer of dollars).

Advertisers know that getting users to convert on ‘shallow goals’ such as account sign-ups, newsletter sign-ups, downloads of informational brochures, watching informational videos, etc., can increase involvement with the site, which ultimately lead to ‘deep goals’ such as a purchase, pricing out options, locating a local store, etc. Knowing the relationship between ‘shallow goals’ and ‘deep goals’ can help advertisers optimize their efforts and money more effectively, especially if they know the rate at which ‘shallow’ and ‘deep’ goals are related, and the first embodiments provides a mechanism for providing such information in an easy-to-read, useful form to advertisers.

One use of the first embodiment is conversion type to conversion type funneling, which can be analyzed by way of a report generated by the first embodiment so as to allow an advertiser to understand the lifetime value of a customer. For example, a site like Amazon or any ecommerce retailer knows that if they are able to convert a customer at some level (e.g., having the customer sign up to receive a newsletter or to become a member on the site), it is likely that customer will come back later and convert on a purchase down the line. Knowing the rate at which a visitor completes goals, over time and multiple visits, can help an advertiser understand the full value of a converter. Knowing this can help them accurately assess what is an acceptable amount of cost to acquire a new customer, knowing their eventual overall ROI over the course of a period of time. Also, knowing the rate at which a visitor complete goals and knowing the expected value of future conversions, can help advertisers understand the full value of a converter.

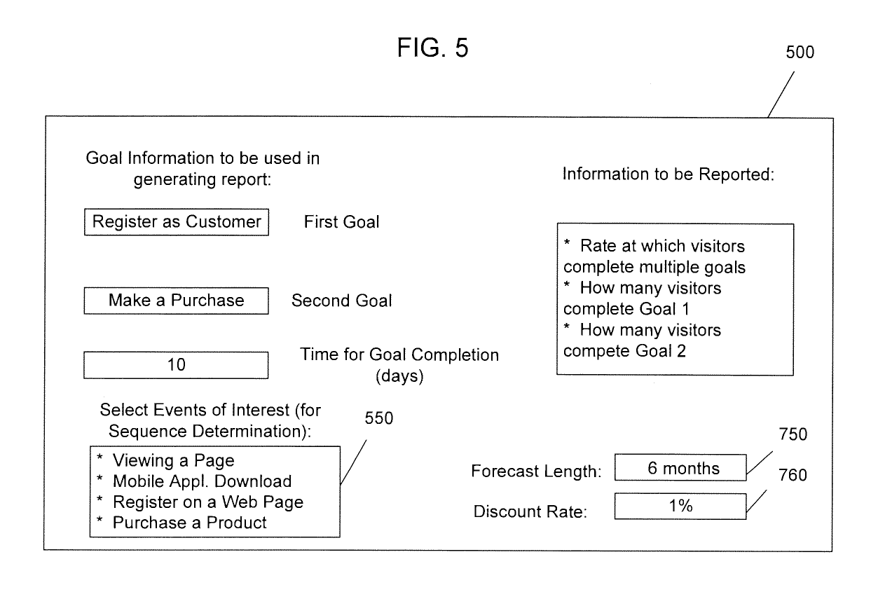

For visitors completing a Goal Type 1, the first embodiment determines how many complete a Goal Type 2 within X days, and provides that information in report form to an advertiser. That is, if the advertiser selects an option to determine how many visitors complete a Goal Type 2 within X days of completing a Goal Type 1, then the first embodiment searches all relevant data and provide that information to the advertiser. FIG. 5 shows a Graphical User Interface (GUI) screen 500 that may be presented to an advertiser to allow the advertiser to obtain such information. The advertiser enters the first type of goal (logging onto the pertinent web site in this example), the second type of goal (registering as a potential customer on the pertinent web site in this example), and the time within which the second type of goal has to be completed from when the first type of goal was completed (“10” days in FIG. 5).

The first embodiment can provide other types of information to the advertiser, for which the advertiser can select via a GUI screen, such as:
What is the rate and frequency with which visitors complete multiple goals (regardless of type)?
How many visitors complete 1 goal? 2 goals? N goals?
What is the drop-off rate between completing goals? (e.g. X users complete a goal but never hit any subsequent goal)
What are the top “correlated” Goal Types, e.g., do Account Sign-ups most often lead to Sales?

The above information is provided to the user in the form of a report, and can include bar charts, pie charts, etc., for ease in presentation of such information to the user.

The first embodiment can obtain such information by way of the following steps and/or procedures:

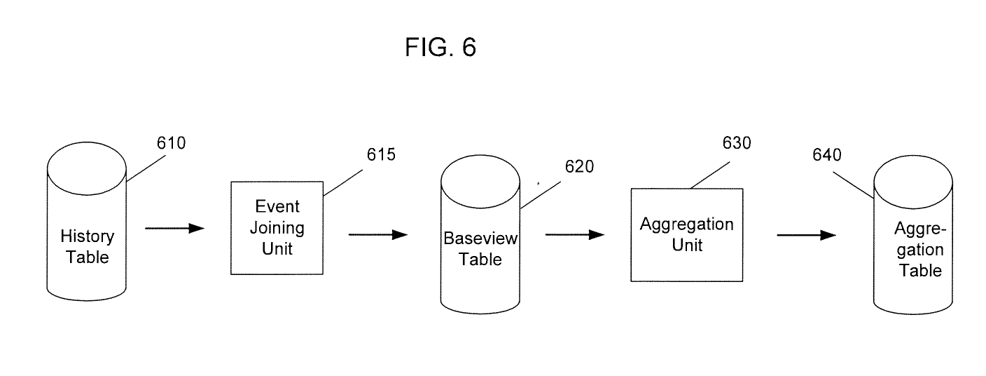

1) To track and collect the pertinent user interaction data, mechanisms such as browser cookies are used to persist visitor sessions across multiple interactions. The Google Analytics tracking cookie is an example of such a cookie, whereby other types of tracking cookies may be used while remaining within the spirit and scope of the invention.
2) Once the data is collected, it is grouped into sequences of events which describe all interaction events (such as impressions, clicks, video plays, widget installations, views of web pages, e-commerce purchases) between the web user and the advertiser for a prescribed time range. In a preferred implementation, there is one sequence per advertiser/web-user pair, which is stored in a History Table 610 as shown in FIG. 6. The report may also include a subset of events within this sequence which the advertiser considers to be “conversions”. Such events could be any event of interest to the advertiser, including purchase, signup, view of a key page, mobile app download, etc. The advertiser can select such a subset of events on the GUI screen shown in FIG. 5, for example, by way of data entry area 550.
3) For each event which the advertiser has designated a conversion, information is extracted about all prior conversion events within a certain time window (e.g. 30 days) to produce a Conversion Path. This can be done in a parallelized, shared method where each advertiser/web user combination is independently processed. In one implementation as shown in FIG. 6, an Event Joiner application 615 performs this procedure and stores the event-joined information in Baseview Table 620. Alternatively, this can be done in a pipelined manner as opposed to a parallelized manner.
4) After the data is extracted and a conversion path is produced, then the data is summarized in the form of a report for the advertiser to be able to easily digest that information. As shown in FIG. 6, the conversion path information stored in Baseview Table 620 is aggregated by an Aggregator application 630 based on the user selections of the type of information to be presented in a report, and the aggregate data is stored in an Aggregates Table 640. The data within the Aggregates Table 640 is then used to provide a report to the advertiser based on the type of information requested by the advertiser.

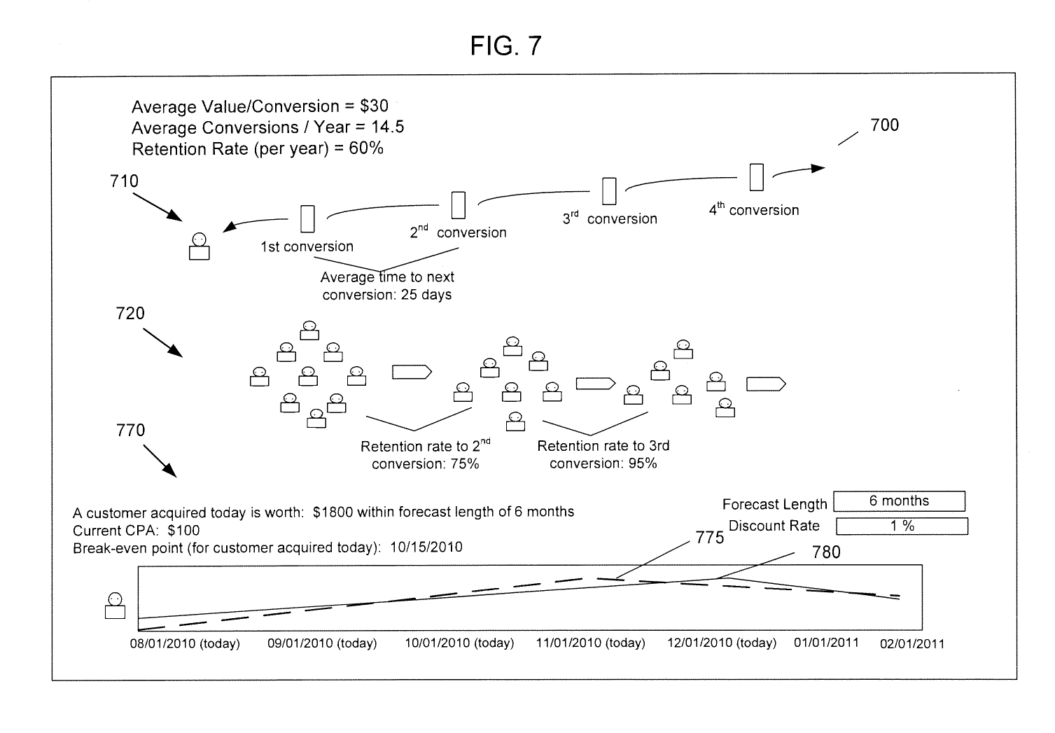

FIG. 7 shows one example of a report 700 that can be provided to an advertiser according to the first embodiment, which is provided to the advertiser by way of a GUI application in one possible implementation. The report 700 shows the rate of dropoff with respect to customers performing a first conversion (e.g., just entering the web site) to a fourth conversion (e.g., purchasing at least two products after registering on the web site as a second conversion and purchasing a product for the first time on that web site as a third conversion). Such information is valuable to advertisers, to let them know which conversions are particularly useful and which ones are not particular useful in terms of ROI. The 710 top portion of the report 700 includes a visual depiction of a customer moving from a first conversion to a fourth conversion, and may include information such as average time to next conversion (25 days in this example).

The report 700 shows in easy-to-view form that the retention rate from the first conversion to the second conversion is 75%, and that the retention rate form the second conversion to the third conversion is 95%. The middle portion 720 of the report 700 provides in easy-to-view form the retention rate from the first conversion to the third conversion.

The first embodiment may also provide information concerning the “worth” of a customer. For example, the report 700 in FIG. 7 provides information to the report reader that a customer acquired today is worth $1800 within a forecast length of 6 months, and in which the break-even point for a customer acquired today is Oct. 15, 2010 (in this example, “today” is Aug. 1, 2010). This in information is provided to the report reader based on historical data obtained from customers performing conversions on the advertiser's web site over a period of time (e.g., over the last year). In FIG. 6, the report reader has the ability to set the forecast length (six months in this example) in a forecast length data entry region 750, and a discount rate (1% in this example) in a discount rate data entry region 760. The report reader can change variables based on the type of information to be reviewed and analyzed, by just changing the values entered in regions 750 and 760 and rerunning the application.

The report 700 also includes a graph region 770 showing the relative value of a customer over time, in this case in one month increments over a six-month period from the time when the customer completed the first conversion. The plot 775 is for a first discount rate (e.g., 1%), and the plot 780 is for a second discount rate (e.g., 2%), in which the user can select as many plots as desired to be provided in the graph region 770. Graph region 770 shows estimated graphs of lifetime cumulative value, in which the user starts with incurring a cost per acquisition of $100, and contributes that much in revenue by 10/15, and goes on to contribute another $1700 down the line. The discount rate value (e.g., 1%, 2%) is used to adjust for comparing future value vs. the present by discounting by an assumed interest rate, i.e., the opportunity cost of having that money locked up and not being able to invest it

The apparatus and method according to the first embodiment can be realized by instructions that upon execution cause one or more processing devices to carry out the processes and functions described above. Such instructions can comprise, for example, interpreted instructions, such as script instructions, e.g., JavaScript® or ECMAScript® instructions, or executable code, or other instructions stored in a computer readable medium. The apparatus and method according to the first embodiment can be distributively implemented over a network, such as a server farm, or can be implemented in a single computer device.

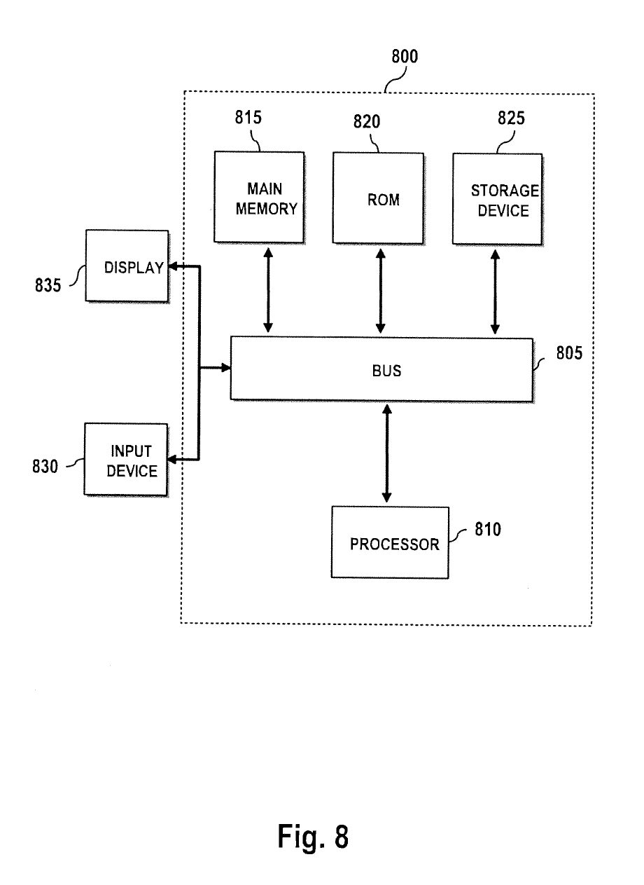

FIG. 8 illustrates a depiction of a computer system 800 that can be used to provide user interaction reports, process log files, implement an illustrative report generating apparatus, or implement an illustrative report generating method. The computing system 800 includes a bus 805 or other communication mechanism for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another embodiment, the input device 830 has a touch screen display 835. The input device 830 can include a cursor control, such as a mouse, a trackball, or cursor direction keys, for communicating direction information and command selections to the processor 810 and for controlling cursor movement on the display 835.

According to various embodiments, the processes that effectuate illustrative embodiments that are described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative embodiments, hard-wired circuitry may be used in place of or in combination with software instructions to implement illustrative embodiments. Thus, embodiments are not limited to any specific combination of hardware circuitry and software.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by at least one computer, first information indicating completion of at least a first conversion and a second conversion by a user;
grouping, by one or more computers, the received first information into at least one sequence of events;
receiving, by the one or more computers, second information indicating which conversions are to be included in a report, and a time frame relating to completion of the conversions;
extracting, by the one or more computers, information from the at least one sequence of events that is pertinent to the received second information; and
providing, by the one or more computers, the extracted information in the form of a report.

2. The method of claim 1, wherein the at least one sequence of events corresponds to all interaction events between the user and a particular advertiser for which the first and second conversions apply to, for a prescribed time range.

3. The method of claim 1, wherein the first conversion corresponds to registering by a user on the particular web site, and wherein the second conversion corresponds to the user making a purchase on the particular web site.

4. The method of claim 1, wherein the second information is obtained by way of a report reader inputting the following information:
a) type of the first conversion; and
b) type of the second conversion.

5. The method of claim 1,
receiving the second information from a report reader, wherein the second information comprises information corresponding to a time by which the second conversion must be completed after the first conversion was completed.

6. The method of claim 1,
wherein the second information is obtained by way of a report reader inputting information corresponding to a number of users who have completed the first conversion.

7. The method of claim 1,
wherein the second information is obtained by way of a report reader inputting information corresponding to a forecast length and discount rate to be applied to the user to determine a return-on-investment with respect to the user.

8. The method of claim 1,
wherein the first and second information correspond to data representing interactions or events.

9. A system comprising:
one or more processors configured to:
receive first information as to completion of at least a first conversion and a second conversion by a user;
group the received first information into at least one sequence of events;
receive second information as to which conversions are to be included in a report, and a time frame with respect to completion of the conversions;
extract information from the at least one sequence of events that is pertinent to the received second information; and
provide the extracted information in the form of a report.

10. The system of claim 9, wherein the at least one sequence of events corresponds to all interaction events between the user and a particular advertiser for which the first and second conversions apply to, for a prescribed time range.

11. The system of claim 9, wherein the first conversion corresponds to registering by a user on the particular web site, and wherein the second conversion corresponds to the user making a purchase on the particular web site.

12. The system of claim 9, wherein the second information is obtained by way of a report reader inputting the following information:
a) type of the first conversion; and
b) type of the second conversion.

13. The system of claim 9,
wherein the second information is obtained by way of a report reader inputting information corresponding to a time by which the second conversion must be completed after the first conversion was completed.

14. The system of claim 9,
wherein the second information is obtained by way of a report reader inputting information corresponding to a number of users who have completed the first conversion.

15. The system of claim 9,
wherein the second information is obtained by way of a report reader inputting information corresponding to a forecast length and discount rate to be applied to the user to determine a return-on-investment with respect to the user.

16. The system of claim 9,
wherein the first and second information correspond to data representing interactions or events.

17. A non-transitory computer implemented storage media configured to store a program product that, when executed on at least one processor performs a method comprising:
receiving first information as to completion of at least a first conversion and a second conversion by a user;
grouping the received first information into at least one sequence of events;
receiving second information as to which conversions are to be included in a report, and a time frame with respect to completion of the conversions;
extracting information from the at least one sequence of events that is pertinent to the received second information; and
providing the extracted information in the form of a report.

18. The non-transitory computer readable medium of claim 17, wherein the at least one sequence of events corresponds to all interaction events between the user and a particular advertiser for which the first and second conversions apply to, for a prescribed time range.

19. The non-transitory computer implemented storage media of claim 17, wherein the first conversion corresponds to registering by a user on the particular web site, and wherein the second conversion corresponds to the user making a purchase on the particular web site.

20. The non-transitory computer implemented storage media of claim 17, wherein the second information is obtained by way of a report reader inputting the following information:
a) type of the first conversion; and
b) type of the second conversion.

21. The non-transitory computer implemented storage media of claim 17,
wherein the second information is obtained by way of a report reader inputting information corresponding to a time by which the second conversion must be completed after the first conversion was completed.

22. The non-transitory computer implemented storage media of claim 17,
wherein the second information is obtained by way of a report reader inputting information corresponding to a number of users who have completed the first conversion.

23. The non-transitory computer implemented storage media of claim 17,
wherein the second information is obtained by way of a report reader inputting information corresponding to a forecast length and discount rate to be applied to the user to determine a return-on-investment with respect to the user.
